(19) United States
(12) Patent Application Publication
(10) Pub. No.: US 2014/0344086 A1
(43) Pub. Date: Nov. 20, 2014

(54) METHOD FOR IMPROVING CUSTOMER SURVEY SYSTEM

(71) Applicant: Poorya Pasta, Tehran (IR)

(72) Inventor: Poorya Pasta, Tehran (IR)

(21) Appl. No.: 13/897,414

(22) Filed: May 19, 2013

(51) Int. Cl. G06Q 30/02; G06Q 20/20

(52) U.S. Cl. CPC G06Q 30/0282; G06Q 20/20
USPC 705/21

(57) ABSTRACT

A global customer satisfaction system includes point-of-sale customer feedback terminals for receiving in-store customer feedback including satisfaction ratings and other customer feedback regarding participating vendors as the customer pays for purchases. The system also includes post-sale customer feedback terminals for receiving more detailed customer feedback regarding the vendors from members after the sales have been completed. The system also includes an aggregation and dissemination system for combining the ratings received form customers into global customer satisfaction ratings for participating vendors, and disseminating the customer satisfaction information through customer satisfaction qualified directories, which are organized or searchable by geographical, type of product or service offered by the participating vendors, and other factors.

### REFERENCE TO RELATED APPLICATION

This application is Continuation in Part of U.S. patent application Ser. No. 13/171,440 filed Jun. 28, 2011.

### TECHNICAL FIELD

The present invention pertains to the fields of vendor directories and customer satisfaction rating systems and, more particularly, to a system for receiving customer satisfaction ratings for participating vendors at points of sale and following the completion of sales, aggregating the ratings received form customers into ratings for participating vendors, and providing a customer satisfaction qualified vendor directory indicating the x customer satisfaction ratings for the participating vendors.

### BACKGROUND

Systems for providing informed opinions regarding products and services have been in use for many years. For example, Consumer Reports™ publishes a guide in which comparable models of products are rated by experts who conduct appropriate research. The results are typically compiled and presented in the form of consumer reports that are organized or searchable by product showing the various competitive models and indicating ratings such as “star ratings” assigned to the various models by the researchers. A wide variety of product and service reviews are currently available, typically organized into guides comparing and rating particular categories of products or services. For example, one can find automotive guides comparing and rating automobiles, movie guides comparing and rating movies, hotel guides comparing and rating hotels, restaurant guides comparing and rating restaurants, and the like.

With the increasing popularity of online shopping, major online sales organizations have also developed systems for receiving and publishing customer feedback regarding particular sellers as a way to provide purchasers with information regarding experience that prior shoppers have had with the vendors. Google™ and Amazon™, for example, provide online shopping customer feedback systems that have become quite sophisticated. These systems typically employ a rating system, such as “star ratings” applicable to particular vendors, and also provide users with access to individual customer comments, product or service reviews, critiques of product or service reviews, and other information. In general, these systems are useful for informing the online shopping community about particular products, service and vendors, including disseminating customer feedback and to potential purchasers about superior and sub-standard performers.

Vendor directories organized by product or service categories have also been in use for many years. These directories are often organized or searchable by geographical area, and for each geographic area are further organized into categories of products and services. The most prominent examples are the “Yellow Page” directories, which are typically published annually on a community-by-community basis. As another example, Thomas Register™ publishes technical directories of vendors for industrial products and services organized by category of product or service. Many variations of these types of vendor directories have been developed over the years and can currently be found both in print and online formats. Records of complaints and other customer feedback information are also made available for individual vendors, for example through the Better Business Bureaus.

Although there are a variety of vendor information systems, product and service rating systems, customer feedback systems, and vendor directories available today, these resources are typically provided separately. As a result, a potential purchaser researching a major purchase may consult with a variety of these resources to become well informed about the choices available. For example, the customer may first conduct research into the available product models using product guides. Having found a specific model of the desired product, the customer may then do some comparative shopping using a Yellow Page vendor directory to find a local or online vendor offering the product at an attractive price. Having found a particular vendor selling the desired model at an attractive price, the careful shopper may check the Better Business Bureau or other available resources or reviews regarding that particular vendor.

While there is a great deal of information available to assist the shopper, accessing and navigating through that information can be tedious and time consuming. In addition, the time needed to make a comprehensive investigation into a particular product or service increases as the amount of available information increases. Of course, specific reviews, ratings and customer feedback statements can be biased, contradictory or even falsified. With the proliferation of free and subscription based information available in print and online, and with the proliferation of advertisements, vendors, websites and blogs, culling through all of the available information and determining which sources are most reliable information can be a substantial challenge.

This situation presents potential customers with challenges as they attempt to wade through all of the available information regarding a prospective purchase, which may be impractical for all but relatively significant purchases. This situation also presents reputable vendors with substantial communication challenges, as they seek cost effective ways to communicate with potential customers in the increasingly cluttered environment of modern communication and advertisement systems.

As a result, there is an ongoing need for cost effective systems to help customers conduct comparative shopping and find reputable vendors, and for reputable vendors to provide relevant information to potential customers.

### SUMMARY OF THE INVENTION

The present invention solves these problems in a system known as the System that creates and provides a network of subscribers and vendors with access to a customer satisfaction qualified vendor directory. At a basic level, the customer satisfaction qualified vendor directory is similar to a conventional Yellow Page vendor directory system that includes participating vendors organized by geographical area and categories of products and services, except that each vendor listing also includes a x customer satisfaction rating. Additional “deep links” may also be provided for accessing maps, customer reviews, vendor statements, coupons, advertisements, and so forth.

The system includes point-of-sale customer feedback terminals for receiving in-store customer feedback including satisfaction ratings and other customer feedback regarding participating vendors as the customers pay for purchases. The system also includes post-sale customer feedback terminals for receiving more detailed customer feedback regarding the vendors from customers after the sales have been completed. The system also includes an aggregation and dissemination system for combining the ratings received form customers into x customer satisfaction ratings for participating vendors, and disseminating the customer satisfaction information through customer satisfaction qualified directories, which are organized or searchable by geography and type of product or service offered by the participating vendors.

Generally described, the invention may be practiced as a customer satisfaction system that includes a number of customer satisfaction rating terminals that receive customer satisfaction feedback from customers related to vendors. The system also includes a customer satisfaction aggregation system that receives the customer satisfaction feedback from the customer satisfaction rating terminals and consolidates the customer satisfaction feedback to provide a customer satisfaction rating associated with each vendor. The system further includes a customer satisfaction dissemination system that provides access to a customer satisfaction qualified vendor directory system. The directory contains a listing of vendor entries, in which each vendor entry contains contact information and the customer satisfaction rating determined by the customer satisfaction aggregation system for the associated vendor. The customer satisfaction qualified vendor directory is also organized or searchable by geographic location of the vendors, and for each geographic location contains vendor entries organized or searchable by category of product or service offered by the vendors.

The customer satisfaction rating terminals typically include a number of point-of-sale terminals located at vendor store locations. Each point-of-sale terminal is associated with a particular vendor, located on the premises of the vendor in association with a purchase check out station where customers pay for purchased items. Each terminal is operable to receive customer satisfaction feedback while the customers are located at the check out station. For example, the point-of-sale terminals may be incorporated into financial card reader stations that are operable for reading financial cards and for receiving customer satisfaction feedback. The customer satisfaction rating terminals may also include a number of post-sale terminals, wherein each post-sale terminal is configured to provide post-sale customer feedback through online communication with the customer satisfaction aggregation system. In particular, any computer with an Internet connection may be used to contact a server operated by the customer satisfaction system and provide post-sale customer feedback.

Optionally, the customer satisfaction system may also include a member reward system that issues rewards to customers who have registered as members of the customer satisfaction system, and who enter customer feedback into the customer satisfaction rating terminals. For example, the rewards may include purchase price discounts, rebates, deposits to savings accounts, points in a points-based rewards program, or another suitable reward program.

The customer satisfaction dissemination system may utilize printed customer satisfaction qualified vendor directories published for various geographic locations. As a more convenient option for many situations, the customer satisfaction qualified vendor directory may be made available to registered members through an online server that provides electronic access to the customer satisfaction qualified vendor directory through a search engine. In this case, the directory is accessed through a menu-driven user interface for the search engine that locates vendor entries organized through a hierarchy of geographic areas, product and service categories, and other factors. The vendor entries may also include hypertext links to additional information, such as maps, customer reviews, coupons, advertisements, and so forth.

It should also be understood that many other advantages and alternatives for practicing the invention will become apparent from the following detailed description of the preferred embodiments and the appended drawings.

### BRIEF DESCRIPTIONS OF THE DRAWINGS

FIG. 1 is conceptual block diagram of a system.

FIG. 2 is a conceptual illustration of a point-of-sale customer satisfaction terminal integrated with a financial card processing terminal configured for in-store sales.

FIG. 3 is a conceptual illustration of a point-of-sale customer satisfaction terminal configured for online sales.

FIG. 4 is a conceptual illustration of the point-of-sale customer satisfaction terminal displaying an set of customer feedback questions.

FIG. 5 is a conceptual illustration of a post-sale customer satisfaction terminal.

FIG. 6 is a conceptual illustration of a search engine user interface for a customer satisfaction qualified vendor directory.

FIG. 7 is a conceptual illustration of a menu system for a geographic area category selection item of the search engine user interface for the customer satisfaction qualified vendor directory.

FIG. 8 is a conceptual illustration of a menu system for a product or service category selection item of the search engine user interface for the customer satisfaction qualified vendor directory.

FIG. 9 is a conceptual illustration of a menu system for a type of venue category selection item of the search engine user interface for the customer satisfaction qualified vendor directory.

FIG. 10 is a conceptual illustration of a menu system for a price range selection item of the search engine user interface for the customer satisfaction qualified vendor directory.

FIG. 11 is a conceptual block diagram of a server system for the system.

### DETAILED DESCRIPTION OF INVENTION

The present invention may be embodied as a System (X system or network) in which members (X customers or purchasers) have the ability to provide instant customer satisfaction ratings applicable to participating vendors (X vendors or sellers) at point-of-sale terminals (X terminals). These customer satisfaction ratings are compiled and published as a composite customer satisfaction indicator (X rating) within one or more customer service qualified vendor directories (X directories), thus providing other members with the ability to preview the aggregate ratings given to any participating X vendor prior to making any purchase. The X directories can be published in print for particular geographic areas or product or service categories. The most effective customer tool for most situations is a searchable, online x vendor directory (X x directory) with a user-friendly interface that allows X customers to easily conduct searches within selected geographic areas, product and service categories, price ranges, and other criteria. In addition to the X rating that provides consolidated customer feedback information at a glance, the x directory also provides “deep links” to more detailed resources, such as customer reviews, professional reviews, critiques of reviews, product catalogs, detailed product specifications, price lists, statements from the vendors, advertisements, comparative listings, maps, and a wide range of other information that they system designers, members, vendors and other users elect to incorporate into the database.

As an organization tool for a wide range of information sources, the X directory is designed, and is expected to further develop over time, to be a robust customer satisfaction database accessed through the X directories. By organizing the customer feedback and other information under a vendor directory system organized by geographic area and product and service categories, the X system can be easily accessed by X members when shopping for many different kinds of products or services in many different locations.

In addition to providing user feedback stations at point-of-sale locations, the X system also allows members to provide post-sale detailed feedback in the form of ratings and commentary. The system also provides the member with the ability to search for X participating vendors based on ratings aggregated into the system and also based on the amount of discount given by the participating vendor to members of the network. These searches can be done online using the system's website or on the system's mobile application created for cellular phones. Ratings, discounts and listings of participating vendors can also be found in hard-copy X vendor directories published regularly by the operators of the X network.

X ratings given at the point of sales typically include a x rating on a scale of one to five for easy completion by the member at the point of sale. The customer feedback station provided at the point-of-sale may also accept more detailed feedback in the form of responses to customer satisfaction related questions in a rating or multiple choice format, such as price satisfaction, checkout time, availability of parking, safety and security, cleanliness of store, variety of selection, shopping experience, and other parameters that can be easily entered at the point of sale. The member may alternatively enter this level of feedback information through a post-sale terminal. In addition, more detailed feedback, such as specific comments, detailed reviews, and so forth are typically entered through the post-sale review, which is typically entered online or through email. The x rating and any other feedback entered at the point of sale is typically entered into the same card-swipe terminal that is used to process the customer's payment. Additional and usually more detailed post-sale feedback can also be entered online concerning factors such as fairness of price, quality of goods and services, after-sales services (warranty, guarantee, etc), written reviews, reviews of reviews, and any other type of suitable feedback.

The X network also provides for the implementation of discounts and other rewards offered by participating vendors to X members. The rewards can be provided in the form of price reductions implemented at the point of sale, rebates, deposits into savings accounts, points systems, or any other suitable reward system. Member discounts may be optional or mandatory, and may be applied to all members on a level basis, may be weighted, and may be used to reward specific factors. For example, members may earn a reward by entering the point-of-sale feedback, entering the post-sale feedback, transacting a certain amount of business within the X network, maintaining a financial account associated with the X network, or other factors. Member discounts may also made available or increased based on other factors, such as the amount of business transacted in the X network, the length of membership, whether the member is also a participating vendor, the amount of business a member-vendor transacts in the X network, the amount of discount that a member-vendor offers to other members, whether the member regularly provides point-of-sale feedback, whether the member regularly provides post-sale feedback; whether the member's reviews are well received in the X network, and so forth.

The participating vendors in the X network is suitable to cover all sectors of retail and wholesale industrial sectors, manufacturers, commercial entities, and service providers, both within the public and private sectors. The potentially x extent of the X system and its all-inclusive nature demonstrate the uniquely wide scope of this x network, which constitutes an important characteristic of the X network. The xization process and major developments in information and communication technologies on the one hand, and the rising demands of the value-conscious customers on the other hand, provides fertile ground for development of the X network in a manner and scope that has the potential to drastically improve over the current state of retail business standards. The main objective of the X network is to provide a system for monitoring and communicating customer satisfaction as expressed by past customer to prospective future customers, so as to reward reputable and high quality vendors with X member good will, as reflected in the customer service information made available to the members though the X vendor directories. The end result of the X network is to strongly improve, and even evolve to a higher stage, the existing retail business standards.

In the current retail sales environment, product and service providers are not required to accept or publish customer satisfaction ratings or other feedback despite the fact that such ratings could improve the quality of goods and services. Of course, those vendors experiencing high levels of customer satisfaction would welcome a low cost ability to receive and disseminate this type of information to their prospective customers, while those vendors experiencing lower levels of customer satisfaction would be less willing to provide this information to prospective customers. The X network provides a mechanism for expression of the degree of customer satisfaction both at the point of sale, typically through entry of a single x rating or a very brief list of rating items concerning the general level of performance, and post-sale, typically allowing more detailed feedback concerning fairness of the price, quality of received goods and services, post-sale activities such as warranty or return issues, detailed product or vendor reviews, and the like.

This mechanism acts to reward superior vendor performance and penalize inferior vendor performance through the communication of customer satisfaction information entered by past customers to potential future purchasers, and thereby serves the interests both sides of the transactions who seek good faith and superior performance. It serves the interests of the customer by providing readily available customer satisfaction information and the possibility of receiving discounts on the prices of goods and service—either as a direct discount paid at the point of sale or as a deposit to the customer's saving account—and also provides to the customer a possibility to rate the performance of vendors both at the point of sale and after the point of sale. The system also serves the interests of those vendors who wish to increase their customer base by consistently providing superior goods and services, as recognized by consumers and communicated to others through the X network.

The X system includes a network of participating vendors and consumer-members who form a customer base for the participating vendors. The objective of the X network is to connect participating vendors with consumer-members, where consumer-members provide customer satisfaction related feedback, upon purchase and later regarding after-sales services. The members may also receive a predetermined discount or other reward from the participating vendors. In a typical implementation of the X system at the point-of-sale location, the member swipes his/her membership card or provides his/her member-id/password (e.g., for online services) and is authenticated by the system. The member then enters customer service satisfaction information and, in cases where member discounts are offered, receives a pre-determined discount, rebate or point award based on the sum-total of the purchase. The specific discounts or other rewards offered by a vendor are typically determined under a X participation agreement between the X system operator and the participating vendor.

The point-of-sale customer satisfaction information is typically received in the form of a x customer satisfaction rating, and may also include a short list of ratings or multiple choice question electronically displayed on a terminal at the point of sale. In particular, the questions may be displayed on the card-reader/keypad that is used to read the customer's magnetic X membership card, and the user responds by selecting a rating or a response from a multiple choice question to which the customer responds by punching in a number using the keypad on the terminal. In electronic points of sales, such as online stores, the user sees the discounted total of the purchases made on the website and a customer-service related question on the same page, and the user responds by selecting one of the provided responses. The discount provided by the participating vendor and the customer feedback question/response may be voluntary feature or a requirements for vendor participation in the X system.

The X system may also include in-store customer feedback stations from which user rates listed items or answers multiple choice questions, such as a card-reader/keypad combo that first recognizes the user at the point of sales from the data written onto the magnetic card. Customer satisfaction and the customer's shopping details are transmitted from the input mechanisms to the X database; where the ratings given concerning a participating vendor are aggregated into existing ratings and the customer's shopping details may be recorded in a database that provides the customer with access to details regarding the customer's shopping history. Users of the X system will be able to find participating vendors and the aggregate of the ratings given to any participating vendor through print or online access to customer satisfaction qualified vendor directories. Individual customers have the ability to view their shopping histories and the savings made through X on the section of the X site that is dedicated to the customer's shopping history.

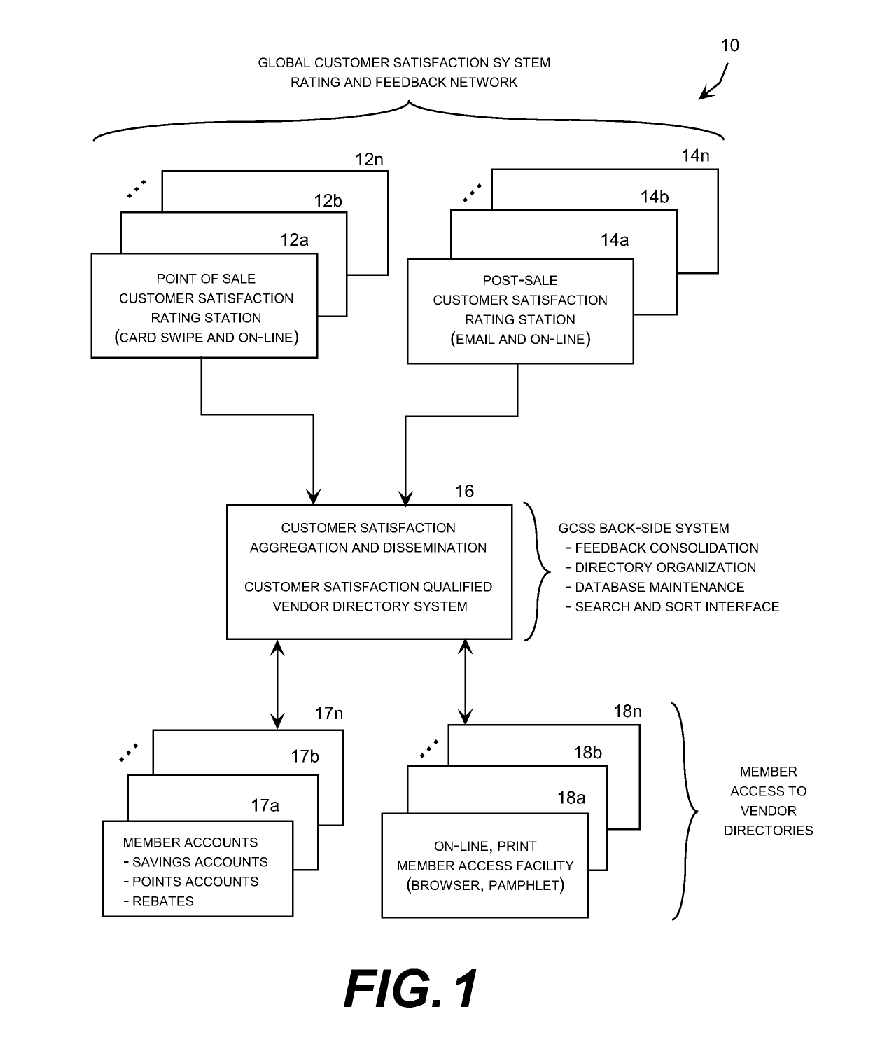

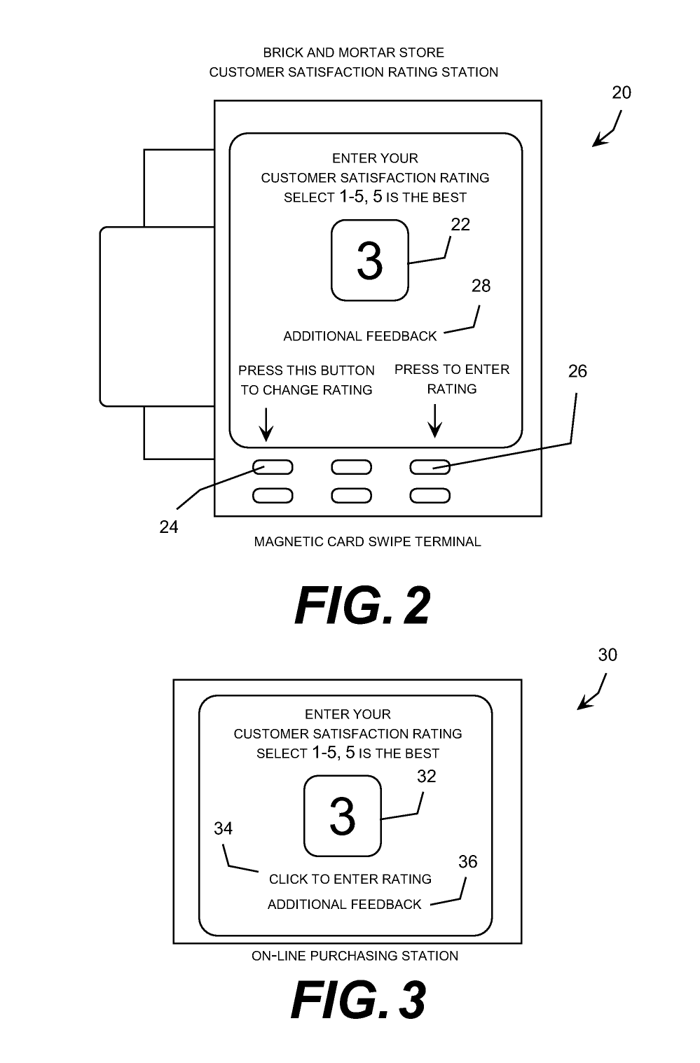

Turning now to the figures, in which like numerals refer to like elements throughout the several figures, a particular embodiment of the invention will be described with reference to the figures. Although the customer satisfaction system can be implement in a wide variety of ways with many areas of sophistication, the figures show a simple example for the purpose of illustrating the principles of the invention. In practice, many different types of customer satisfaction systems with different features and levels of sophistication may be implemented, and the features implemented by these systems may vary for different types of vendors and members. FIG. 1 is conceptual block diagram of a system 10. The system includes a number of point-of sale customer feedback stations 12a-n. Some of these rating systems may be specifically designed for in-store locations, and other may be configure for online shopping. For both types of stations, the point-of sale customer feedback stations 12a-n are configured to receive customer feedback in the form of customer satisfaction ratings that can be quickly entered at the time that the customer pays for a purchase. Typically, the point-of sale customer feedback stations utilize a simple “1 through 5” or similar ranking system that allows the customer to enter the satisfaction rating quickly as the customer completes the purchase check-out process. The point-of sale customer feedback may also allow the user to enter additional structured feedback, such as ratings for a list of specific items ore multiple choice answers to a list of specific questions. Specific examples are described further with reference to FIGS. 2-4.

The system 10 also includes a number of post-sale customer feedback stations 14a-n, which are typically configured for allowing customers to enter more detailed feedback after the purchase has been completed, when time pressures of completing a purchase are not present. In particular, any computer with an internet connection can be used an a post-sale customer feedback station whenever the customer would like to enter the feedback. Typically, a X vendor number printed on a sales receipt or the participating vendor's name will be all that the user needs to know to locate the correct vendor the online X directory to enter a variety of types of customer feedback. Customers can use the post-sale customer feedback stations to enter feedback that is not yet available or too time consuming to enter at the point of sale, such as detailed statements regarding their shopping experience and any product support, return or warranty issues that occurred after the sale. The members can also enter product reviews, vendor reviews, critiques of reviews, and so forth. The objective using two types of customer feedback stations is to have point-of-sale customer feedback stations 12a-n that all or most members are prompted to use very quickly to entered structured form feedback as purchases are completed, and post-sale customer feedback stations 14a-n available for that those customers who which to make more detailed, non-structured form commentary when time permits. A specific example of a post-sale feedback terminal is described further with reference to FIG. 5.

The system 10 also includes a customer feedback aggregation and dissemination system 16, which is typically configured as an Internet server system. This system aggregates the feedback received from various customers into a consolidated customer satisfaction ranking, typically on a scale from one to five, for each participating vendor in the network. For example, the ratings entered by customers can be aggregated by averaging or weighted averaging taking certain factors into account in the weighting factors. For example, more recent ratings may be given more weight that older ratings, ratings from higher volume shoppers may be given more weight that ratings from lower volume shoppers, ratings from members who have been registered in the network longer may be given more weight than rating from more recent members, and so forth. Many different techniques can be used to combine and normalize the customer ratings received for a particular vendor into an aggregate or xrating, and different aggregation algorithms may be used for different product or service categories.

The customer feedback aggregation and dissemination system 16 also makes the customer satisfaction information to members of the network. Specifically, customer satisfaction information is disseminated to the members though a customer satisfaction qualified vendor directory. This is similar to a traditional yellow page directory, except that it typically covers multiple geographic areas, and that each vendor entry includes customer satisfaction feedback information, such as a x X rating. In particular, the customer satisfaction feedback information typically includes at least the aggregate or x rating determined by the X system from member feedback, typically expressed on a scale of one to five, and a number of “deep links” to more detailed customer feedback information. Accordingly, the x X rating for a particular vendor will be a dynamic figure that can change over time as new customer feedback is entered into he customer feedback aggregation and dissemination system 16 and older feedback ages becomes less relevant.

The system 10 also includes a system of member accounts 17a-n for its members. The member accounts allow members to register, input and change contact information, obtain vendor directories, enter post-sale feedback, and so forth. Each member account may include a reward system for providing the member with an incentive for using the X network. As a first example, the member may receive a discount on the price of goods or services applied at the point of sale. As another example, the member may receive a rebate deposited into a savings account maintained by the operator of the X network. A points systems may also be used as another example. Different members may receive different levels of rewards, for example based on the amount of business they do through the network, the length of time they have been a member in the system, whether they provide customer service feedback, whether they are a vendor participating in the network, and other factors.

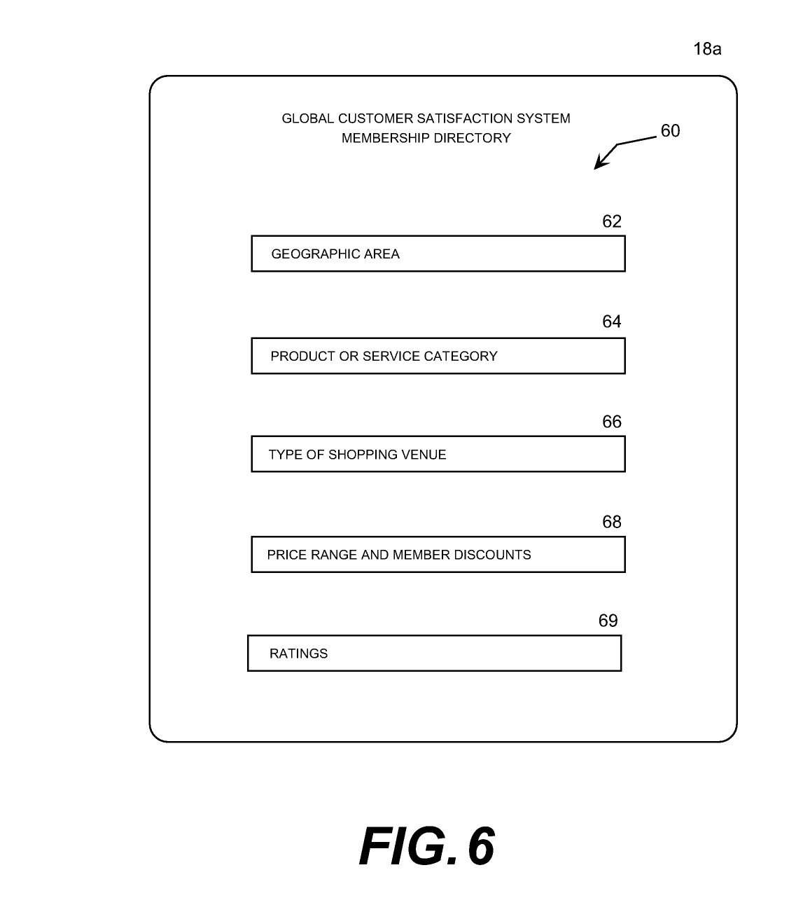

The customer satisfaction qualified vendor directory can be published in printed form for a variety of geographic locations, and a more convenient dissemination mechanism is the online directory accessed through a search engine with a menu-driven user interface. In general, the members access the customer satisfaction qualified vendor directories 18a-n through printed or online access, as desired to support their shopping needs. A specific example of an online customer satisfaction qualified vendor directory is described further with reference to FIGS. 6-10.

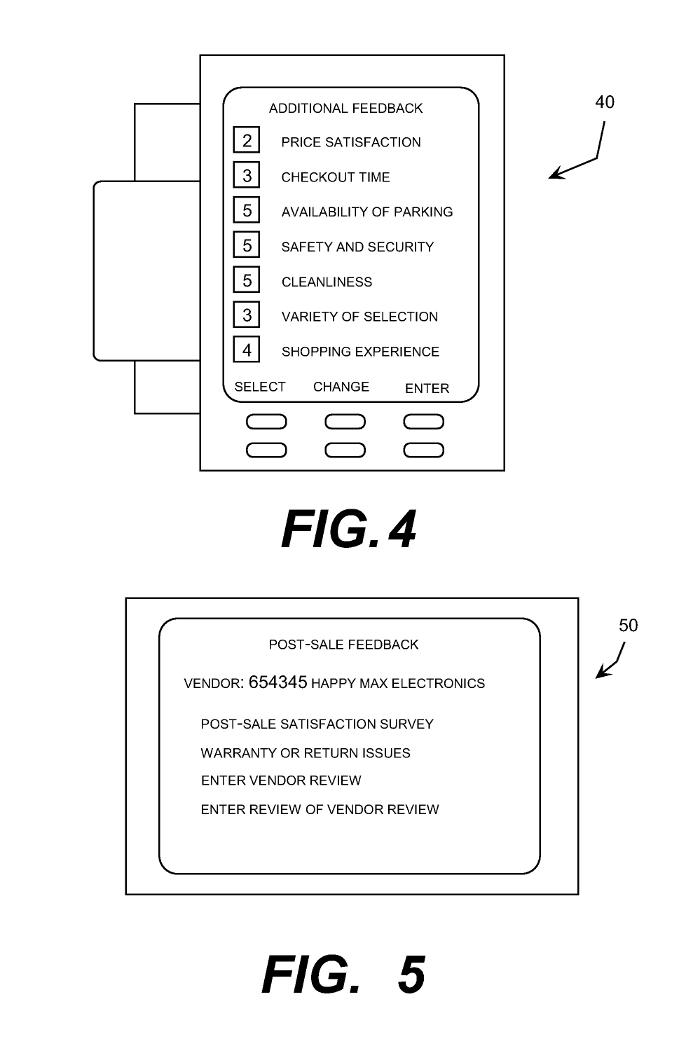

FIG. 2 is a conceptual illustration one type of customer feedback station, in this example a point-of-sale customer satisfaction terminal 20 integrated with a financial card processing terminal configured to process customer payments for in-store sales. To receive customer feedback quickly and easily as the customer pays for a purchase, the point-of-sale customer satisfaction terminal preferably enables the user to enter a single x rating on a scale from one to five. The rating is displayed in a window 22, and the customer toggles a first button 24 to change the rating and a second button 26 to enter the rating. The point-of-sale customer satisfaction terminal may also have a mechanism, such as a touch-screen field 28 that the customer can touch with a finger or stylus, to access an additional screen for entering customer feedback information. An example of a additional screen for entering customer feedback information is shown in FIG. 4 FIG. 3 is a conceptual illustration of a point-of-sale customer satisfaction terminal 30 configured for online sales. This visible interface similar to the customer satisfaction terminal 20 used for in-store sales, except that it is suitable for displayed on a computer screen as the customer goes through the online shopping check out process. In this example, the user interface includes a window 30 where the customer enters the desired rating, a button or field where the user clicks to enter the rating, and a button or field where the user clicks to access an additional customer feedback panel. The point-of-sale customer satisfaction terminal should be intuitively easy to understand at a glance and very quick and easy to use. Although may different options could be implemented for this function, the example illustrated meets these basic objectives while still allowing the customer to enter meaningful feedback information very quickly.

FIG. 4 is a conceptual illustration of the point-of-sale customer satisfaction terminal displaying a set of customer feedback rating items 40. In this example, the terminal displays a number items that the customer can rate individually on a scale from one to five. In this particular illustration, the user can use three of the buttons on the terminal to select among the items, toggle through the available ratings, and enter the feedback. For example, the customer can enter a separate rating for “price satisfaction,” “checkout time,” “availability of parking,” “safety and security,” “cleanliness,” “variety of selection,” and “shopping experience.” Of course, other types of questions such as multiple choice could be displayed, additional user feedback panels could be implemented, and the specific items inquired about on the panel is a matter of design choice and may be different for different types of stores.

FIG. 5 is a conceptual illustration of a post-sale customer satisfaction terminal 50. This is a simple example that allows the member to identify a specific vendor, for example by entering a vendor X number, vendor name, or linking to the post-sale feedback from a vendor entry. Many different options may be used for receiving post-sale feedback including unstructured formats, such as textual reviews written by customers, critiques of reviews, and other types of detailed feedback.

FIG. 6 is a conceptual illustration of a search engine user interface 60 for accessing a customer satisfaction qualified vendor directory. In general, the directory is organized under a hierarchy of geographical areas, and for each geographical area further organized under a hierarchy of product and service categories. This is illustrated by the geographical area selection field 62 and the product or service category field 64. These selection items allow the member accessing the directory to select a specific geographical area and product and service category, and the search engine displays the entries for participating vendors meeting that criteria. In this particular example, the customer satisfaction qualified vendor directory can also be searched with additional qualifiers entered through a type of shopping venue selection box 66, a price range and member discounts selection box 68, and a ratings selection box 69. As an example, the member could enter “Miami, Fla.” with the geographical area selection field 62, “electronic stores” with the product or service category field 64, “shopping mall” with the type of shopping venue selection box 66, select “at least five percent member discount” with the price range an member discounts selection box 68, and “at least a X rating of 3” with the ratings selection box 69. The search engine then return all of the vendor listing meeting those criteria. Each vendor listing includes contact information for the participating vendor and the X rating determined by the X system for that vendor, and may include links to a variety of other items, such as maps, coupons, advertisements, vendor reviews, product catalogs, etc.

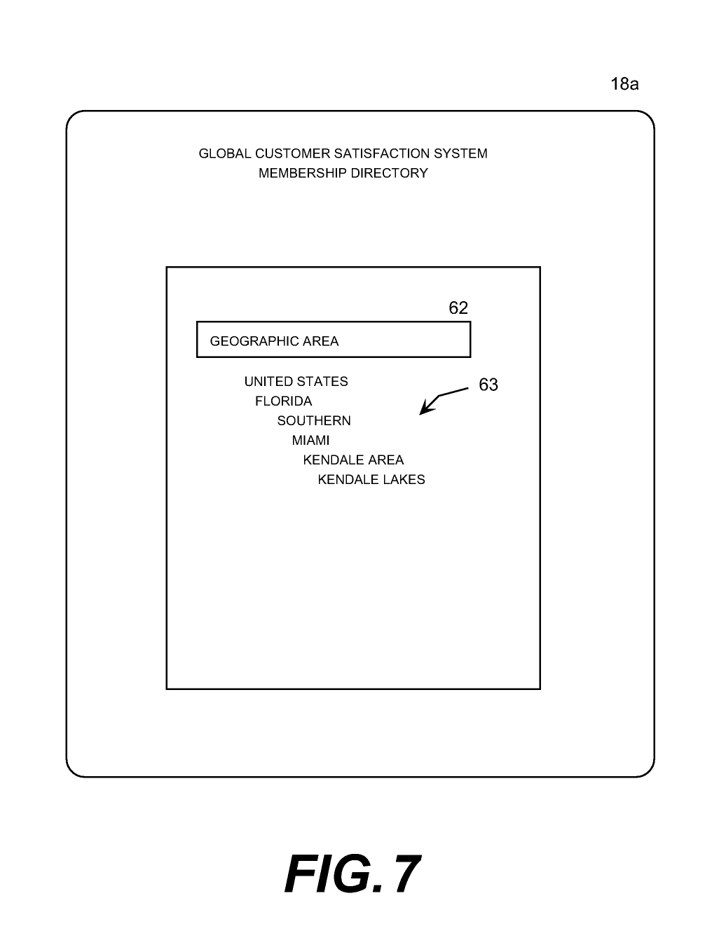

FIGS. 7-10 illustrate another specific example of specific criteria selections for the search engine showing examples of pull down menus for the selection boxes. As a particular example, FIG. 7 shows an illustrative geographical hierarchy 63 pulled down from the geographic area selection box 62. This particular hierarchy extends from a country selection down to a neighborhood, in case from “United States” to “Florida” to “Southern” to “Miami” to “Kendale Area” to “Kendale Lakes.” The selection panels allow various alternatives to be selected at each level. For example, other countries at the level of the “United States,” other U.S. states at the level of “Florida,” and so forth.

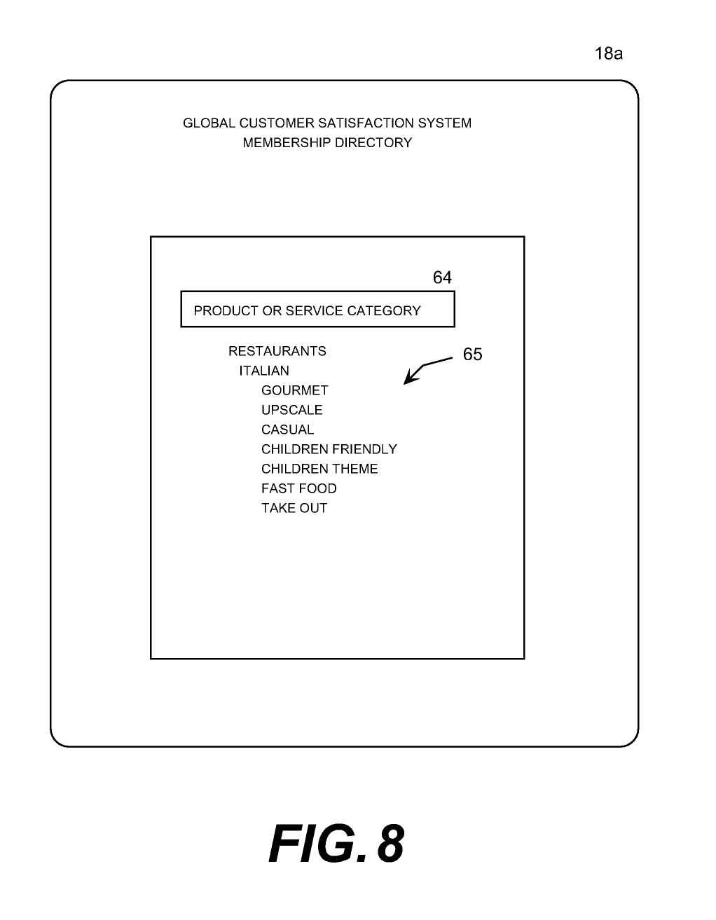

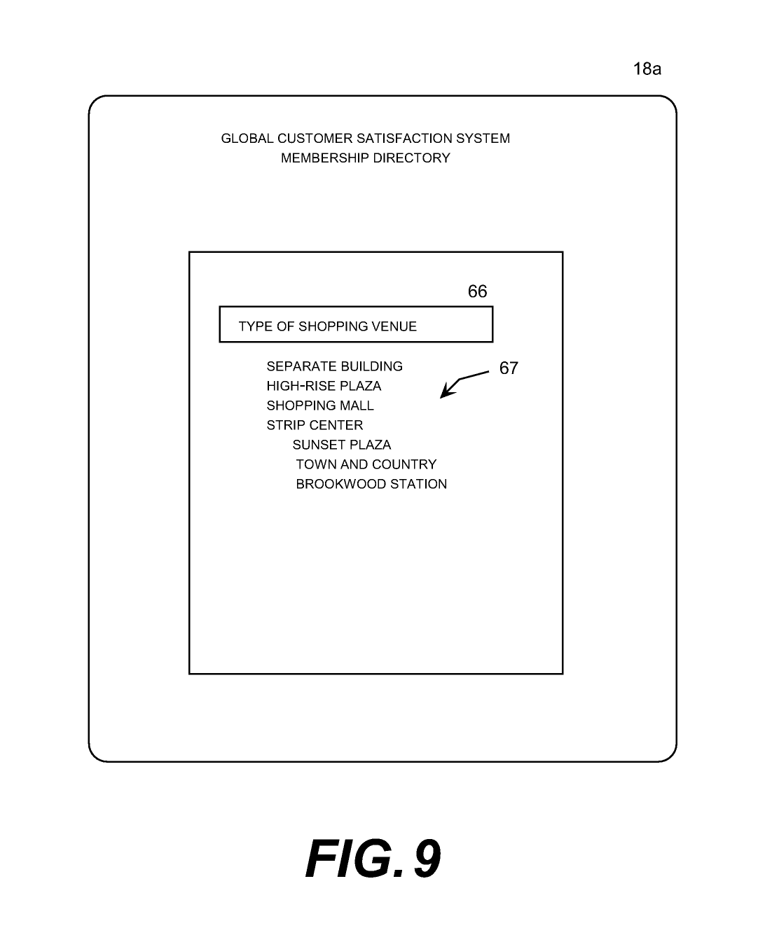

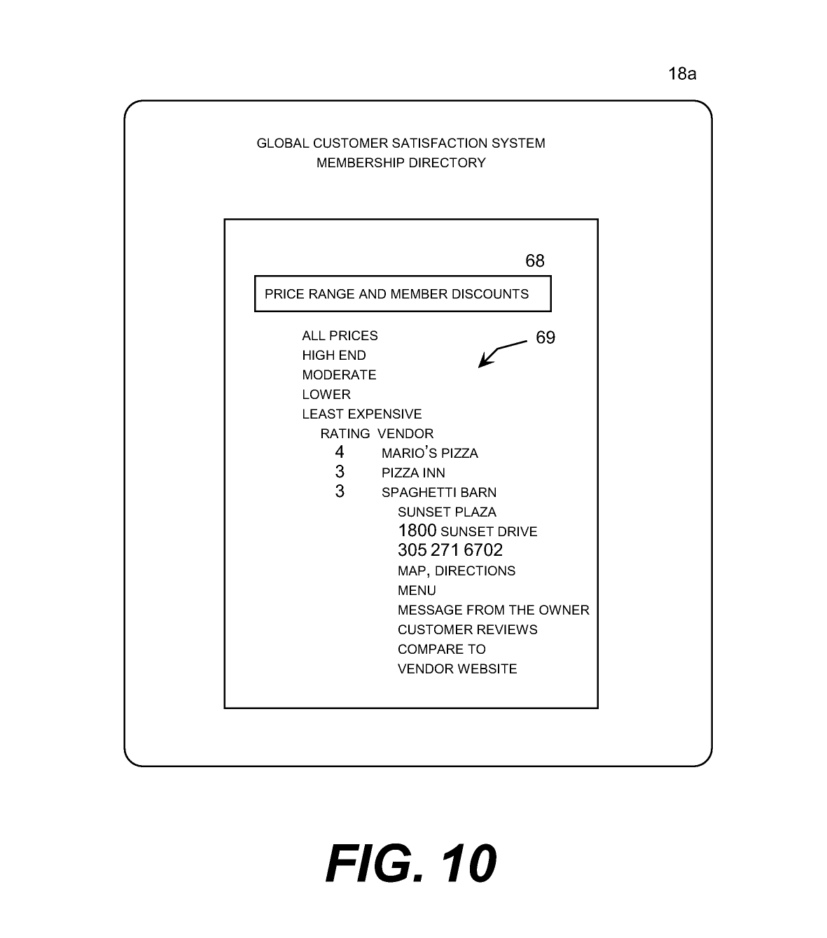

FIG. 8 shows an illustrative product and service category hierarchy 65 pulled down from the product and service category selection box 64. This particular hierarchy extends from “restaurants” to “Italian” to several restaurant types including “gourmet,” “upscale” and so forth. It will be appreciated that different hierarchies of sub-categories will be appropriate for different product and service categories and that many different options will be available for organizing the vendor directory under a hierarchical system for product and service categories. FIG. 9 shows an illustrative shopping venue hierarchy 67 pulled down from the type of shopping venue selection box 66. This particular hierarchy extends from types of venues, such as “separate building” and “high-rise plaza,” to specific venues, such as “Sunset Plaza” and “Town and Country.” FIG. 10 shows an illustrative price range hierarchy 69 pulled down from the price range and member discounts selection box 66. This particular hierarchy shows various price ranges from “high end” to “least expensive.” As shown in FIG. 8, the specific vendor entry “Spaghetti Barn” includes the GCDD x rating for the vendor, contact information for the vendor including address and telephone, and hypertext links to additional resources including a map, directions, a message from the vendor, customer reviews, comparative vendors, and a link to the vendor's website. Of course, this particular vendor entry is merely illustrative and the actual set of information and links will vary from vendor to vendor.

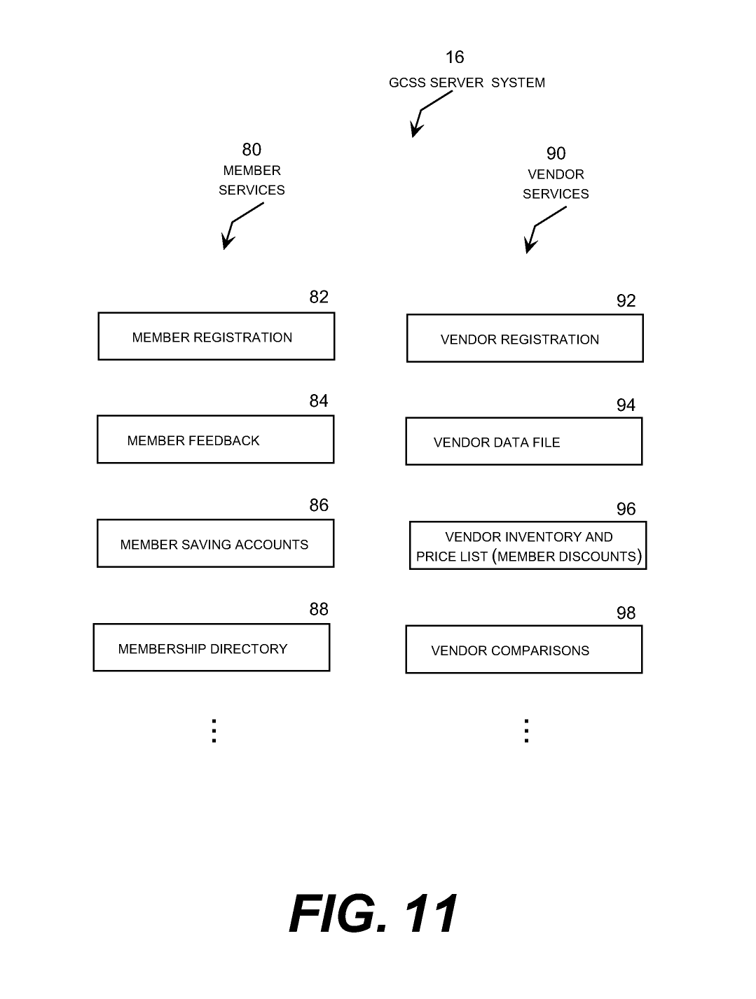

FIG. 11 is a conceptual block diagram of a server system for the system 10. In general, the system provides a number of member services 80 and a number of vendor services 90. The member services typically a member registration selection item 82 where customers can register and update their personal contact information, a member feedback selection item 84 where members can enter feedback and reviews and other relevant information, a member savings account selection item 86 where members can review their savings from rebates, points or other reward system, and a membership directory selection item 88 where users can access the customer satisfaction qualified directory and save search results from the directory search engine. For participating vendors, the vendor services include a vendor registration selection item 92, a vendor data file selection item 94 where the vendor can enter data to be included in the vendor entry in the customer satisfaction qualified directory, such as coupons, advertisements, a vendor inventory and price list selection item 96, and vendor comparisons 98. These particular member and vendor services are merely illustrative, and other features and services may be implemented to meet the needs of various members and vendors.

In view of the foregoing, it will be appreciated that present invention provides significant improvements in customer satisfaction systems. It should be understood that the foregoing relates only to the exemplary embodiments of the present invention, and that numerous changes may be made therein without departing from the spirit and scope of the invention as defined by the following claims.

What is claimed is:

1. A customer satisfaction system comprising:
(a) a plurality of customer satisfaction rating terminals configured to receive customer satisfaction feedback from customers related to a plurality registered vendors, the customer satisfaction feedback received in the form of customer satisfaction ratings entered at the time a customer pays for a purchase while the customers are located at a purchase checkout station, the plurality of customer satisfaction rating terminals comprise a plurality of point-of-sale terminals, wherein each of the point-of-sale terminals is assigned to a particular vendor and is located on the premises of the vendor in association with a purchase checkout station, and a plurality of post-sale terminals, wherein each of the post-sale terminals is configured to receive more detailed customer feedback after the purchase has been completed from locations other than the point-of-sale locations;
(b) a server to which the plurality of customer rating terminals are connected, the server configured to store and access member and vendor services including member and vendor registration information, member feedback, member savings accounts, membership directory, vendor data files, vendor inventory and pricelists, and vendor comparisions; the server further comprising a member discounts component for enabling vendors to issue rewards to customers;
(c) a customer satisfaction aggregation system configured to receive the customer satisfaction feedback from the each of the plurality of customer satisfaction rating terminals and consolidating the customer satisfaction feedback to provide an aggregate customer satisfaction rating for each registered vendor; and
(d) a customer satisfaction disemination system that provides access to a customer satisfaction qualified vendor directory comprising a plurality of vendor entries, wherein each vendor entry comprises contact information and the aggregate customer satisfaction rating determined by the customer satisfaction aggregation system for the associated vendor, the vendor entries are organized and searchable by geographic location of the plurality of registered vendors, category of product or service offered by the vendors, shopping venue type of the vendors, price range of the products and/or services offered by the vendors, and a combination thereof;
wherein, a vendor can register therewith as a compound vendor so as to register a plurality of vendors thereunder as branch or dependent vendors, the compound vendor can view the customer satisfaction ratings of each of the branch vendors thereof at one place in the vendor directory accessed via login details validated by the customer satisfaction dissemination system upon registration.

2. The customer satisfaction system of claim 1, wherein a post-sale terminal comprises a computing device connected to the customer satisfaction aggregation system via the Internet.

3. The customer satisfaction system of claim 1, wherein the rewards are issued to customers who enter customer satisfaction feedback into the customer satisfaction rating terminals.

4. The customer satisfaction system of claim 1, wherein the rewards comprise purchase price discounts, rebates, deposits to savings accounts, or points in a points-based rewards program.

5. The customer satisfaction system of claim 1, wherein each vendor entry comprises hyperlinks to maps, advertisements, customer reviews, and so on.

6. The customer satisfaction system of claim 1, wherein a vendor entry is created when a vendor registers with the customer satisfaction system.

7. The customer satisfaction system of claim 1, wherein each vendor entry further comprises a plurality of product and/or service entries pertaining to a plurality of products and/or services that are sold by the vendor; the customer satisfaction system configured to receive customer satisfaction feedback for each of purchased products and/or services via a customer satisfaction rating terminal wherein, an aggregated customer satisfaction feedback of each of the purchased products and/or services is to be displayed along with the product and/or service entries pertaining thereto.

8. The customer satisfaction system of claim 1, wherein the customer satisfaction rating of each of the branch vendors is aggregated into a compound customer satisfaction rating.

9. The customer satisfaction system of claim 1, wherein a vendor can register as a branch vendor under a registered compound vendor wherein, the compound vendor needs to authenticate the registration thereof as the branch vendor thereof.

10. The customer satisfaction system of claim 11, wherein the compound vendor can view the customer satisfaction ratings of each of the branch vendors thereof at one place in the vendor directory accessed via login details validated by the customer satisfaction dissemination system upon registration.

11. The customer satisfaction system of claim 1, wherein a vendor comprises a non-profit entity such as a governmental establishment.

12. The customer satisfaction system of claim 1, wherein customers, upon registration with the customer satisfaction system, can interact with fellow registered customers and vendors.

13. A customer satisfaction system comprising:
(a) a plurality of customer satisfaction rating terminals configured to receive customer satisfaction feedback from customers related to a plurality registered vendors, the customer satisfaction feedback received in the form of customer satisfaction ratings entered at the time a customer pays for a purchase while the customers are located at a purchase checkout station, the plurality of customer satisfaction rating terminals comprise a plurality of point-of-sale terminals, wherein each of the point-of-sale terminals is assigned to a particular vendor and is located on the premises of the vendor in association with a purchase checkout station, and a plurality of post-sale terminals, wherein each of the post-sale terminals is configured to receive more detailed customer feedback after the purchase has been completed from locations other than the point-of-sale locations, each post-sale terminal comprises a computing device;
(b) a server to which the plurality of customer rating terminals are connected, the server configured to store and access member and vendor services including member and vendor registration information, member feedback, member savings accounts, membership directory, vendor data files, vendor inventory and pricelists, and vendor comparisions; the server further comprising a member discounts component for enabling vendors to issue rewards to customers who enter customer satisfaction feedback into the customer satisfaction rating terminals, the rewards comprising purchase price discounts, rebates, deposits to savings accounts, or points in a points-based rewards program;
(c) a customer satisfaction aggregation system configured to receive the customer satisfaction feedback from the each of the plurality of customer satisfaction rating terminals via the Internet and consolidating the same to provide an aggregate customer satisfaction rating for each registered vendor; and
(d) a customer satisfaction disemination system that provides access to a customer satisfaction qualified vendor directory comprising a plurality of vendor entries, wherein each vendor entry in turn comprises contact information, the aggregate customer satisfaction rating determined by the customer satisfaction aggregation system for the associated vendor, hyperlinks to maps, advertisements, customer reviews, and a plurality of product and/or service entries pertaining to a plurality of products and/or services that are sold by the vendor, wherein customer satisfaction feedback is received for each of purchased products and/or services via customer satisfaction rating terminals wherein, an aggregated customer satisfaction feedback of each of the purchased products and/or services is to be displayed along with the product and/or service entries pertaining thereto; the vendor entries are organized and searchable by geographic location of the plurality of registered vendors, category of product or service offered by the vendors, shopping venue type of the vendors, price range of the products and/or services offered by the vendors, and a combination thereof;
wherein, a vendor can register therewith as a compound vendor so as to register a plurality of vendors thereunder as branch or dependent vendors, the compound vendor can view the customer satisfaction ratings of each of the branch vendors thereof at one place in the vendor directory accessed via login details validated by the customer satisfaction dissemination system upon registration.

14. A customer satisfaction system comprising: a server and a plurality of customer satisfaction rating terminals: the server configured to store and access member services including member registration information, member feedback, member savings accounts and a membership directory;
the server configured to store and access vendor services including vendor registration information, vendor data files, vendor inventory and price lists, and vendor comparisons;
the server and the plurality of customer satisfaction rating terminals configured to execute a member directory component including a geographic area hierarchy that includes neighborhood granularity, a product or service category hierarchy, a shopping venue type hierarchy that classifies the shopping venue type, a price range hierarchy and member discounts component that provides implementation of discounts and rewards offered by participating vendors and a ratings component;
the plurality of customer satisfaction rating terminals configured to receive-customer satisfaction feedback from customers regarding a plurality registered vendors, wherein the plurality of customer satisfaction rating terminals comprise a plurality of point-of-sale terminals, wherein each of the plurality of point-of-sale terminals is assigned to a particular vendor, the each of the plurality of point-of-sale terminals is located on the premises of the vendor in association with a purchase checkout station, and configured to receive customer satisfaction feedback in the form of customer satisfaction ratings entered at the time that the customer pays for a purchase while the customers are located at the checkout station, wherein the system further comprises at least one of a plurality of post-sale customer feedback stations or search engine portals configured to receive via the server, more detailed customer feedback after the purchase has been completed from locations other than the point-of-sale locations;
a customer satisfaction aggregation system configured to receive the customer satisfaction feedback from the each of the plurality of point-of-sale terminals and the post-sale customer feedback stations customer satisfaction rating terminals and consolidating the customer satisfaction feedback to provide an aggregate customer satisfaction rating for each registered vendor;
a customer satisfaction dissemination system operable to provides access to a customer satisfaction qualified vendor directory containing a plurality of vendor entries, wherein each vendor entry contains contact information and the aggregate customer satisfaction rating determined by the customer satisfaction aggregation system for the associated vendor, and wherein the customer satisfaction qualified vendor directory is organized and searchable by geographic location of the plurality of registered vendors, and for each geographic location contains vendor entries organized and searchable by category of product or service offered by the vendors.
